(19) United States
(12) Patent Application Publication
(10) Pub. No.: US 2005/0263171 A1
(43) Pub. Date: Dec. 1, 2005

(54) Finishing processes for improving fatigue life of metal components

(76) Inventors: Ming Wu, Bethel, CT (US); Mark Polinsky, Harwinton, CT (US); Dennis Norwich, Sandy Hook, CT (US); Scott Carpenter, Fremont, CA (US)

Correspondence Address: CANTOR COLBURN, LLP, 55 GRIFFIN ROAD SOUTH, BLOOMFIELD, CT, 06002, US

(21) Appl. No.: 11/078,983

(22) Filed: Mar. 11, 2005

Related U.S. Application Data
(60) Provisional application No. 60/552,277, filed on Mar. 11, 2004.

(51) Int. Cl. B08B 7/00

(52) U.S. Cl. 134/6; 134/33

(57) ABSTRACT

Disclosed herein is a method for polishing metallic articles comprising immersing a portion of the metallic article in abrasive media; tumbling the metallic article in a centrifugal force field; and passivating the metallic article in a passivating solution comprising an acid. Disclosed herein too is a method comprising immersing a portion of the metallic article in a first abrasive media; tumbling the metallic article in a first centrifugal force field; immersing the metallic article in a second abrasive media; tumbling the metallic article in a second centrifugal force field; and passivating the metallic article in a passivating solution comprising an acid.

### CROSS-REFERENCE TO RELATED APPLICATIONS

This application claims the benefit of U.S. Provisional Application Ser. No. 60/552,277 filed Mar. 11, 2004, the entire contents of which are hereby incorporated by reference.

### BACKGROUND

This disclosure is directed to finishing processes for improving the fatigue life of metal components.

Medical implants such as stents generally have very high fatigue requirements in order to survive for a desired length of time set forth by the food and drug administration (FDA) and/or other governing bodies. Fatigue in arterial implants is brought on by the contracting and expanding of blood vessels that occurs with every heartbeat. The fatigue life (in cycles) is calculated by multiplying the number of heartbeats per minute by the number of minutes that the device must survive in vitro. In order for a device manufacturer to use a part manufactured from a shape memory alloy, it is desirable for the part to perform for a specified fatigue life that has been calculated by the method defined above.

In general, the fatigue life of a given part is dependent upon the presence of stress concentrators in the part. Some of these stress concentrators arise from the production process utilized to manufacture the part. Some of the stress concentrators are due to defects introduced during manufacturing, some arise because of imperfections in the base material, and some are time dependent stress risers resulting from corrosion in vivo.

There are multiple avenues currently being used to improve fatigue life. Stringent visual inspection requirements are placed on components for surface defects. Components having such surface defects are post processed using chemical etching and/or electropolishing to remove sharp edges, to smooth out surface imperfections, and to remove a fine layer of material from the surface of the part. After the inspection and post processing, the components are passivated to provide corrosion resistance to the body.

While the chemical etching generally removes a uniform layer of material from the outer surfaces of the part, it promotes etching at different rates based on the cleanliness, imbedded process imperfections, and base material uniformity. This differential rate can give rise to defects that reduce the fatigue life of manufactured articles. It is therefore desirable to devise new methods for polishing articles manufactured from shape memory alloys so that such articles can endure for time periods exceeding 100,000 cycles, during cyclic fatigue testing.

### BRIEF SUMMARY

Disclosed herein is a method for polishing metallic articles comprising immersing a portion of the metallic article in abrasive media; tumbling the metallic article in a centrifugal force field; and passivating the metallic article in a passivating solution comprising an acid.

Disclosed herein too is a method comprising immersing a portion of the metallic article in a first abrasive media; tumbling the metallic article in a first centrifugal force field; immersing the metallic article in a second abrasive media; tumbling the metallic article in a second centrifugal force field; and passivating the metallic article in a passivating solution comprising an acid.

Disclosed herein too are articles manufactured by the aforementioned methods.

### DESCRIPTION OF FIGURES

FIG. 1 is a picture showing a device that can subject an article to a gravitational force field during the tumbling process;

FIG. 2 is graphical representation of a bar chart showing the average fatigue life for the samples prepared by the standard method, etched using chemical etching as well as for the samples that were subjected to polishing by the tumbling method;

FIG. 3 is graphical representation of a bar chart showing the fatigue survival rate for the samples prepared by the standard method, etched using chemical etching as well as for the samples that were subjected to polishing by the tumbling method;

FIG. 4 is a graphical representation of cyclic polarization curves of barrel tumbled Ti-55.8% Ni wire specimens;

FIG. 5 is a graphical representation of cyclic polarization curves of barrel tumbled Ti-55.8% Ni wire specimens after passivation treatment at 40° C. for 40 minutes in a 21 wt % nitric acid solution;

FIG. 6 is a graphical representation of cyclic polarization curves of barrel tumbled Ti-55.8% Ni wire specimens after passivation treatment at 23° C. for 40 minutes in a 28 wt % nitric acid solution;

FIG. 7 is a graphical representation of cyclic polarization curves of barrel tumbled Ti-55.8% Ni wire specimens after passivation treatment at 50° C. for 40 minutes in a 28 wt % nitric acid solution;

FIG. 8 is graphical depiction of the survival rate of the number of samples measured as a percentage of the total that were subjected to the test. The samples were split up into 6 batches and each batch was tested separately for 90,000 cycles;

FIG. 9 is a graphical representation of the percent survival rate for samples subjected to differing numbers of cycles;

FIG. 10 is a graphical representation of the percent survival rate for samples that were not subjected to finishing or were subjected to an electropolishing finishing process, a chemical etch finishing process or a finishing process (denoted as “improved”) using the abrasive particles described herein;

FIG. 11 is a graphical representation of the percent strain versus the cycles to failure for untreated samples and samples subjected to the (improved) finishing process; and

FIG. 12 is a graphical representation depicting sub-surface residual stress in untreated samples and samples (improved) as a result of treatment with the abrasive particles described herein.

### DETAILED DESCRIPTION OF PREFERRED EMBODIMENTS

Disclosed herein are mechanical methods that may be used to polish articles made from metals in a manner effective to improve the fatigue life of the article. The metals are generally subjected to polishing by mechanical tumbling in the presence of an abrasive having a bulk density of less than or equal to about 1.5 g/cm². In one embodiment, the method comprises immersing a portion of the metallic article in abrasive media and tumbling the metallic article in a centrifugal force field. In another embodiment, the method comprises immersing a portion of the metallic article in a first abrasive media and tumbling the metallic article in a first centrifugal force field; followed by immersing the metallic article in a second abrasive media and tumbling the metallic article in a second centrifugal force field. In one embodiment, the first centrifugal force field is equal to the second centrifugal force field. In another embodiment, the first centrifugal force field is not equal to the second centrifugal force field.

The articles to be polished are also subjected to passivation in order to improve corrosion resistance. The passivation is generally conducted in a passivating solution comprising an acid.

The mechanical methods advantageously promote an increase in the fatigue life of the articles beyond the fatigue life of similar articles treated by other commercially available process such as chemical polishing, electrochemical polishing, and the like. In one embodiment, the fatigue life of the articles polished by such mechanical methods exceeds at least 100,000 cycles in cyclic fatigue testing. This method may be advantageously used to polish articles and to remove scale, oxides, burrs, and other defects that tend to reduce the fatigue life of the article.

The abrasive media used in the tumbling may be organic particles, inorganic particles, or a combination of organic and inorganic particles that generally have a bulk density of less than or equal to about 1.5 g/cm³. The organic particles may be synthetic organic particles, natural organic particles, or a combination comprising at least one of the foregoing organic particles. Synthetic organic particles are those derived from thermoplastic polymers, thermosetting polymers or combinations of thermoplastic polymers with thermosetting polymers.

The polymers may be oligomers, polymers, ionomers, dendrimers, copolymers such as block copolymers, graft copolymers, star block copolymers, random copolymers, or the like, or combinations comprising at least one of the foregoing polymers. The polymers may comprise thermoplastic polymers, thermosetting polymers, or a combination comprising thermosetting polymers with thermosetting polymers. Suitable examples of thermoplastic polymers that can be used as abrasive media are polyacetals, polyacrylics, polyalkyds, polycarbonates, polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyorganosiloxanes, or the like, or combinations comprising at least one of the foregoing thermoplastic polymers. A suitable commercially available organic particle for polishing is F-10 or F-20 cones. These are commercially available from Grav-I-Flo Corporation based in Sturgis, Mich.

Blends of thermoplastic polymers may also be used. Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyethylene/nylon, polyethylene/polyacetal, and the like, and mixtures comprising at least one of the foregoing blends of thermoplastic polymers.

The thermoplastic polymers have number average molecular weights of 1,000 to 1,000,000 grams/mole. In one embodiment, the thermoplastic polymers have number average molecular weights of 3,000 to 500,000 grams/mole. In another embodiment, the thermoplastic polymers have number average molecular weights of 5,000 to 100,000 grams/mole. In yet another embodiment, the thermoplastic polymers have number average molecular weights of 10,000 to 30,000 grams/mole. It is to be noted that for purposes of this specification, all ranges are inclusive and combinable.

Thermosetting polymers may also be used as synthetic organic abrasive particles. Suitable examples of thermosetting polymers include polyurethanes, epoxies, phenolics, polyesters, polyamides, polyorganosiloxanes, or the like, or a combination comprising at least one of the foregoing thermosetting polymers. Blends of thermosetting polymers as well as blends of thermoplastic polymers with thermosetting polymers can be utilized.

The synthetic organic abrasive particles may comprise fillers if desired. The fillers may be organic and/or inorganic fillers. Suitable examples of organic fillers are impact modifiers, naturally occurring organic fillers, or the like, or a combination comprising at least one of the foregoing fillers.

A particularly useful class of impact modifiers comprises the AB (diblock) and ABA (triblock) copolymers and core-shell graft copolymers of alkenylaromatic and diene compounds, especially those comprising styrene and either butadiene or isoprene blocks. The conjugated diene blocks may be partially or entirely hydrogenated, whereupon they may be represented as ethylene-propylene blocks and the like and have properties similar to those of olefin block copolymers. Examples of triblock copolymers of this type are polystyrene-polybutadiene-polystyrene (SBS), hydrogenated polystyrene-polybutadiene-polystyrene (SEBS), polystyrene-polyisoprene-polystyrene (SIS), poly(α-methylstyrene)-polybutadiene-poly(α-methylstyrene) and poly(α-methylstyrene)-polyisoprene-poly(α-methylstyrene). Particularly preferred triblock copolymers are available commercially as CARIFLEX®, KRATON D®, and KRATON G® from Shell.

Also suitable as impact modifiers are core-shell type graft copolymers and ionomer resins, which may be wholly or partially neutralized with metal ions. In general, the core-shell type graft copolymers have a predominantly conjugated diene or crosslinked acrylate rubbery core and one or more shells polymerized thereon and derived from monoalkenylaromatic and/or acrylic monomers alone or in combination with other vinyl monomers. Other impact modifiers include the above-described types containing units having polar groups or active functional groups, as well as miscellaneous polymers such as Thiokol rubber, polysulfide rubber, polyurethane rubber, polyether rubber (e.g., polypropylene oxide), epichlorohydrin rubber, ethylene-propylene rubber, thermoplastic polyester elastomers, thermoplastic ether-ester elastomers, and the like, as well as mixtures comprising any one of the foregoing. Specially preferred amongst the ionomer resins is SURLYN® available from Du Pont.

Impact modifiers may be used in amounts greater than or equal to about 0.5, preferably greater than or equal to about 1.0, more preferably greater than or equal to about 1.5 wt % based upon the total weight of the abrasive particles. In general it is desirable to have the impact modifier present in an amount of less than or equal to about 20, preferably less than or equal to about 15, more preferably less than or equal to about 10 wt % of the total weight of the abrasive particles.

Naturally occurring organic fillers that may be used in the synthetic organic abrasive particles are ground nutshells or seeds. Suitable examples of ground nut shells or seeds are walnut shell particles, coconut shell particles, peach pits, brazil nut covers, cherry pits, apricot pits, plum pits, olive seeds, prune seeds, cob meal, grape seeds, peanut hulls, almond shells, cotton seed hulls, acorn shells, orange seeds, grapefruit seeds, lemon seeds, watermelon seeds, or the like, or a combination comprising at least one of the foregoing naturally occurring organic fillers.

The inorganic fillers used in the synthetic organic abrasive particles may be particulates, fibers, platelets, whiskers, fractals or combinations comprising at least one of the foregoing forms. The inorganic fillers may be metal oxides, metal carbides, metal silicates, metal carbonitrides, or the like, or combinations comprising at least one of the foregoing fillers. Metal oxides are generally preferred.

Suitable examples of inorganic fillers that may be used in the synthetic organic abrasive particles are short inorganic fibers, including processed mineral fibers such as those derived from blends comprising at least one of aluminum silicates, aluminum oxides, magnesium oxides, and calcium sulfate hemihydrate, boron fibers, ceramic fibers such as silicon carbide, and fibers from mixed oxides of aluminum, boron and silicon sold under the trade name NEXTEL® by 3M Co., St. Paul, Minn., USA. Also included among fibrous fillers are single crystal fibers or “whiskers” including silicon carbide, alumina, boron carbide, iron, nickel, copper. Fibrous fillers such as glass fibers, basalt fibers, including textile glass fibers and quartz may also be included. In a preferred embodiment, glass fibers are used as the non-conductive fibrous fillers to improve conductivity in these applications. Useful glass fibers can be formed from any type of fiberizable glass composition and include those prepared from fiberizable glass compositions commonly known as “E-glass,” “A-glass,” “C-glass,” “D-glass,” “R-glass,” “S-glass,” as well as E-glass derivatives that are fluorine-free and/or boron-free.

Natural organic particles that may be used as abrasive particles are similar to the naturally occurring organic fillers that are used in the synthetic organic abrasive particles. These are ground nutshells or seeds. Suitable examples of ground nut shells or seeds are walnut shell particles, coconut shell particles, peach pits, brazil nut covers, cherry pits, apricot pits, plum pits, olive seeds, prune seeds, grape seeds, peanut hulls, almond shells, cotton seed hulls, acorn shells, orange seeds, grapefruit seeds, lemon seeds, watermelon seeds, or the like, or a combination comprising at least one of the foregoing naturally occurring organic fillers.

The abrasive particles used in the polishing are those having a bulk density of less than or equal to about 1.5 g/cm³. In one embodiment, the abrasive particles have a bulk density of about 0.1 to about 1.45 g/cm³. In another embodiment, the abrasive particles have a bulk density of about 0.3 to about 1.40 g/cm³. In yet another embodiment, the abrasive particles have a bulk density of about 0.5 to about 1.3 g/cm³.

There is no particular limitation to the shape of the abrasive particles, which may be for example, spherical, irregular, plate-like or whisker like. The abrasive particles may generally have average largest dimensions of less than or equal to about 10,000 micrometers (μm). In one embodiment, the particles may have average largest dimensions of less than or equal to about 8,000 μm. In another embodiment, the particles may have average largest dimensions of less than or equal to about 6,000 μm. In yet another embodiment, the particles may have average largest dimensions of less than or equal to about 4,000 μm. In yet another embodiment, the particles may have average largest dimensions of less than or equal to about 2,000 μm.

As stated above, the particles may generally have average largest dimensions of less than or equal to about 10,000 μm. In one embodiment, more than 90% of the particles have average largest dimensions less than or equal to about 10,000 μm. In another embodiment, more than 95% of the particles have average largest dimensions less than or equal to about 10,000 μm. In yet another embodiment, more than 99% of the particles have average largest dimensions less than or equal to about 10,000 μm. Bimodal or higher particle size distributions may be used.

The abrasive particles may be used in dry form or in the form of a slurry. The dry form is one where the abrasive particles are not mixed with any fluids during the polishing process. A slurry, as defined herein, is one where the abrasive particles are mixed with a fluid that does not completely dissolve them. Suitable examples of fluids that may be used in the slurry are water, alcohols such as methanol, ethanol, isopropanol, or the like, acetone, toluene, oligomers of ethylene glycol, or the like, or a combination comprising at least one of the foregoing.

When a slurry is used, the fluid may be present in an amount of 5 to about 95 wt %, based on the combined weight of the fluid and the abrasive particles in the slurry. In one embodiment, the fluid may be present in an amount of 10 to about 90 wt %, based on the combined weight of the fluid and the abrasive particles in the slurry. In another embodiment, the fluid may be present in an amount of 20 to about 60 wt %, based on the combined weight of the fluid and the abrasive particles in the slurry. In yet another embodiment, the fluid may be present in an amount of 25 to about 50 wt %, based on the combined weight of the fluid and the abrasive particles in the slurry.

The method of polishing the articles by tumbling the article in the presence of abrasive media is generally carried out in a single operation, preferably two or more operations. In one embodiment, the two or more operations may be carried out either in a batch process or in a continuous process. The operations may be conducted in a single device or a number of different devices. In one method of polishing the articles, the articles to be polished are placed in a tumbling device along with the abrasive media. The tumbling device is one that can promote agitation of the abrasive media in which the article is disposed. The tumbling device imposes a centrifugal force field on the abrasive media as well as the article. In the process of tumbling the articles to be polished are first placed in a barrel along with the abrasive particles. The barrel is subjected to rotation in a first direction about a first axis while simultaneously revolving in a second direction about a second axis. In one embodiment, during the process of rotation of the barrel, the first and the second axis are always equidistant from one another. In another embodiment, during the process of rotation of the barrel, the first and the second axis are not equidistant from one another. The first and second directions can be the same if desired. Alternatively, the first and the second directions may be opposed to each other. For example, if the first direction is clockwise the second direction may be counterclockwise if desired or vice versa. The strong centrifugal forces developed in the barrel during the rotation results in an extremely high rate of work due to the weight increase of the tumbling article.

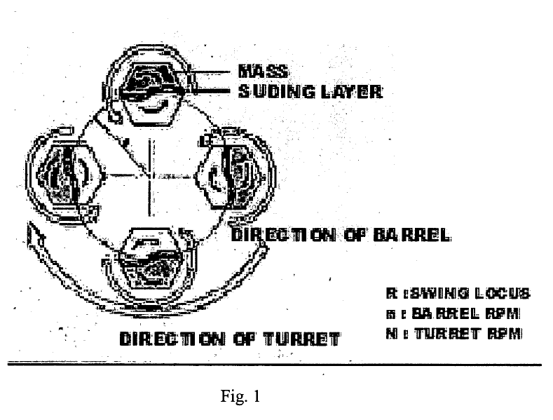

A suitable example of a commercially available tumbling device is a GYRA FINISH® machine having model numbers C-4-806, C-4-810, and C-4-545 respectively. These are available from Grav-I-Flo Corporation based in Sturgis, Mich. This device is shown in the FIG. 1 and is equipped with four barrels spaced evenly on a heavy-duty turret. A vertical line traversing the geometric center of each barrel constitutes the first axis for that barrel. A vertical line traversing the center of the turret constitutes the second axis. As the turret is rotated in one direction, the barrels rotate in the opposite direction. Thus the barrels revolve around the vertical axis of the turret in one direction while rotating about their own axis in a direction opposite to the direction in which the barrels are revolving. When the turret speed exceeds 60 rpm the article in the barrel is subjected to high compressive forces causing the article to slide to the furthest wall of the barrel. The energy created in this process produces surface finishes up to thirty (30) times faster than methods such as tumbling barrels and vibratory mills.

Each barrel generally rotates at a speed of about 45 to about 240 revolutions per minute (rpm) about the first axis. In one embodiment, each barrel rotates at a speed of about 60 to about 220 revolutions per minute (rpm) about the first axis. In another embodiment, each barrel rotates at a speed of about 80 to about 200 revolutions per minute (rpm) about the first axis. In yet another embodiment, each barrel rotates at a speed of about 100 to about 180 revolutions per minute (rpm) about the first axis. The barrel generally revolves about the second axis at a speed of greater than or equal to about 60 rpm. It is generally desirable to have the barrel revolve around the second axis at a speed greater than or equal to about 100 rpm, preferably greater than or equal to about 150 rpm, and more preferably greater than or equal to about 200 rpm.

Within each barrel, it is generally desirable to use a volume ratio of about 0.5 to about 1000. The volume ratio as defined herein is the volume of the abrasive particles to the article. In one embodiment, it is desirable to use a volume ratio of about 20 to about 800. In another embodiment, it is desirable to use a volume ratio of about 40 to about 600. In yet another embodiment, it is desirable to use a volume ratio of about 60 to about 200. An exemplary volume ratio is about 100. It is generally desirable to fill the barrels with the article and the abrasive media to a volume exceeding about 10% of the total volume of the barrel. In one embodiment, it is desirable to fill the barrels with the article and the abrasive media to a volume exceeding about 30% of the total volume of the barrel. In another embodiment, it is desirable to fill the barrels with the article and the abrasive media to a volume exceeding about 50% of the total volume of the barrel. In yet another embodiment, it is desirable to fill the barrels with the article and the abrasive media to a volume exceeding about 75% of the total volume of the barrel.

The tumbling is generally conducted for a time period of about 30 seconds to about 5 hours. In one embodiment, the tumbling is conducted for a time period of about 1 minute to about 4 hours. In another embodiment, the tumbling is conducted for a time period of about 2 minutes to about 2 hours. In yet another embodiment, the tumbling is conducted for a time period of 3 minutes to about 30 minutes. While the tumbling is generally conducted at room temperature, it may be conducted at temperatures both above and below room temperature if desired.

The energy used during the tumbling is about 0.1 to about 200 kilowatt hour/kilogram (kwhr/kg) of the metal. In one embodiment, the energy used during the tumbling is about 10 to about 180 kwhr/kg of the metal. In another embodiment, the energy used during the tumbling is about 20 to about 160 kwhr/kg of the metal. In yet another embodiment, the energy used during the tumbling is about 40 to about 150 kwhr/kg of the metal. An exemplary amount energy used during the tumbling is about 137 kwhr/kg.

As noted above, the tumbling may be performed in a single operation or in more than one operation. When the tumbling is performed in more than one operation in the same device, it may be desirable to use different types of abrasive particles for each operation. Different time periods as well as different temperatures may also be used for each operation. For example, it may be desirable to use synthetic organic abrasive particles for the first operation, while it may be desirable to use naturally occurring organic abrasive particles for the second operation, and so on. Similarly, while it may be desirable to use the abrasive particles in dry form for the first operation, it may be desirable to use the abrasive particles in the form of slurry for the second operation.

The method of polishing articles is effective in removing burrs, flaws, pits, or other forms of stress concentrators from metals. It may advantageously be used on soft metals such as shape memory alloys to improve the fatigue life of the metal especially when compared with other processes that may be used to polish the metal. In one embodiment, the fatigue life of metals polished by utilizing the process is greater than or equal to about 100,000 cycles, preferably greater than or equal to about 150,000 cycles, more preferably greater than or equal to about 250,000 cycles, and most preferably greater than or equal to about 280,000 cycles.

The metals that may be subjected to the mechanical tumbling may be any type of metal such as gold, silver, nickel, cobalt, niobium, platinum, palladium, iron, titanium, copper, zinc, aluminum, or the like, or a combination comprising at least one of the foregoing metals. Preferred metals that may be polished by the process include softer metals such as shape memory alloys. It is generally desirable for the shape memory alloys to have an elastic modulus of less than or equal to about 840,000 kg/cm² (1.2×10⁶ pounds per square inch).

In one embodiment, a preferred shape memory alloy is a nickel titanium alloy. Suitable examples of nickel titanium alloys are nickel-titanium-niobium, nickel-titanium-copper, nickel-titanium-iron, nickel-titanium-hafnium, nickel-titanium-palladium, nickel-titanium-gold, nickel-titanium-silver, nickel-titanium-platinum alloys and the like, and combinations comprising at least one of the foregoing nickel titanium alloys.

Preferred nickel-titanium alloys that may be subjected to tumbling are those that may be used in the medical devices and generally comprise nickel in an amount of about 54.5 weight percent (wt %) to about 57.0 wt % based on the total composition of the alloy. Within this range it is generally desirable to use an amount of nickel greater than or equal to about 54.8, preferably greater than or equal to about 55, and more preferably greater than or equal to about 55.1 weight % based on the total composition of the alloy. Also desirable within this range is an amount of nickel less than or equal to about 56.9, preferably less than or equal to about 56.7, and more preferably less than or equal to about 56.5 wt %, based on the total composition of the alloy.

Another preferred nickel titanium alloy that may be subjected to tumbling is a nickel-titanium-niobium (NiTiNb) alloy that comprises nickel in an amount of about 30 to about 60 wt % and niobium in an amount of about 1 wt % to about 50 wt %, with the remainder being titanium. The weight percents are based on the total composition of the alloy. Within the range for nickel, it is generally desirable to use an amount greater than or equal to about 35, preferably greater than or equal to about 40, and more preferably greater than or equal to about 47 wt %, based on the total composition of the alloy. Also desirable within this range is an amount of nickel less than or equal to about 55, preferably less than or equal to about 50, and more preferably less than or equal to about 49 wt %, based on the total composition of the alloy. Within the range for niobium, it is generally desirable to use an amount greater than or equal to about 11, preferably greater than or equal to about 12, and more preferably greater than or equal to about 13 wt %, based on the total composition of the alloy. Also desirable within this range, is an amount of niobium less than or equal to about 25, preferably less than or equal to about 20, and more preferably less than or equal to about 16 wt %, based on the total composition of the alloy.

In one embodiment, it is generally desirable to use shape memory alloys having pseudo-elastic properties and/or superelastic properties, which are formable into complex shapes and geometries without the creation of cracks or fractures. In one embodiment, a β titanium alloy having linear elastic, linearly superelastic, pseudoelastic or superelastic properties may be subjected to tumbling to preserve its fatigue properties.

In the β titanium alloy, the stability of the β phase can be expressed as the sum of the weighted averages of the elements that comprise the alloy, often known as the molybdenum equivalent (Mo_{eq.}). P. Bania, Beta Titanium Alloys in the 1990's, TMS, Warrendale, 1993, defines the Mo_{eq.} in the following equation (1) as
Mo_{eq.}=1.00Mo+0.28Nb+0.22Ta+0.67V+1.43Co+1.60Cr+0.77Cu+2.90Fe+1.54Mn+1.11Ni+0.44W−1.00Al (1)
wherein Mo is molybdenum, Nb is niobium, Ta is tantalum, V is vanadium, Co is cobalt, Cr is chromium, Cu is copper, Fe is iron, Mn is manganese, Ni is nickel, W is tungsten and Al is aluminum and wherein the respective chemical symbols represent the amounts of the respective elements in weight percent based on the total weight of the alloy. It is to be noted that aluminum can be substituted by gallium, carbon, germanium or boron.

Hf (hafnium), Sn (tin) and Zr (zirconium) exhibit similarly weak effects on the β stability. Although they act to lower the β transus, these elements are considered neutral additions. US Air Force Technical Report AFML-TR-75-41 has suggested that Zr has a small Mo equivalent of 0.25 while Al is an α stabilizer having a reverse effect to that of Mo. Hence, the Mo equivalent in weight percent is calculated according to the following equation (2) which is a modified form of the equation (1):
Mo_{eq.}=1.00Mo+0.28Nb+0.22Ta+0.67V+1.43Co+1.60Cr+0.77Cu+2.90Fe+1.54Mn+1.11Ni+0.44W+0.25(Sn⁺ Zr+Hf)−1.00Al (2)

In general it is desirable to have a shape memory alloy that displays superelasticity and/or pseudoelasticity, which has a molybdenum equivalent of about 7 to about 11 wt %, based upon the total weight of the alloy. In one embodiment, it is desirable to have a shape memory alloy that displays superelasticity and/or pseudoelasticity, which has a molybdenum equivalent of about 7.5 to about 10.5 wt %, based upon the total weight of the alloy. In another embodiment, it is desirable to have a shape memory alloy that displays superelasticity and/or pseudoelasticity, which has a molybdenum equivalent of about 8 to about 10 wt %, based upon the total weight of the alloy. In yet another embodiment, it is desirable to have a shape memory alloy that displays superelasticity and/or pseudoelasticity, which has a molybdenum equivalent of about 8.5 to about 9.8 wt %, based upon the total weight of the alloy.

Preferred β titanium alloys are those comprising an amount of about 8 to about 12 wt % of molybdenum, about 2 to about 6 wt % aluminum, up to about 2 wt % vanadium, up to about 4 wt % niobium, with the balance being titanium.

Suitable examples of articles that may be subjected to mechanical polishing are eyewear frames, face inserts or heads for golf clubs, medical devices such as orthopedic prostheses, spinal correction devices, fixation devices for fracture management, vascular and non-vascular stents, minimally invasive surgical instruments, filters, baskets, forceps, graspers, orthodontic appliances such as dental implants, arch wires, drills and files, and a catheter introducer (guide wire).

In one embodiment, the articles after being subjected to mechanical polishing are further subjected to passivation in an acid bath to facilitate resistance against chemical corrosion. Suitable examples of such acids are nitric acid, sulfuric acid, hydrochloric acid, or the like, or a combination comprising at least one of the foregoing acids. An exemplary acid is nitric acid. When nitric acid is used for purposes of passivation, it is generally desirable to use the nitric acid at a concentration of about 10 to about 50 wt %, based on the total weight of the passivating solution. The remainder of the passivating solution is preferably water and/or deionized water. However, other fluids such as organic solvents (e.g., alcohols, acetone, toluene) may also be used if desired. The total time for passivation may be about 3 to about 120 minutes, with a time period of greater than or equal to about 5 minutes preferred. The temperature for passivation is about 10 to about 100° C., with a temperature of about 20 to about 50° C. generally preferred.

The following example is meant to be exemplary, not limiting, illustrate some of the various embodiments of the tumbling process and the alloy compositions whose fatigue life are improved as a result of such treatment.

### EXAMPLES

### Example 1

In this example, the polishing was performed in two operations. The metal that was polished was Nitinol having nickel in an amount of 55.9 wt % (Ti-55.9 wt % Ni), with the remainder being titanium. The material was in the form of straight wires having a length of approximately 10 centimeters. 20 pieces were placed in each barrel for purposes of tumbling. Approximately one liter of abrasive was used with liquid to cover the top of the media and 20 ml of CLC 580 cleaning solution.

In the first operation, the abrasive particles are synthetic organic abrasive particles containing ceramic fillers. F-20 cones were used for the first operation. The F-20 cones are commercially available from Grav-i-Flo Corporation. In the first operation, the synthetic organic abrasive particles and the article to be polished are placed in the barrel and tumbled for a time period of about 10 to about 20 minutes. The barrel was rotated at a speed of 240 rpm, while the barrels revolved around the turret at a speed of 240 rpm.

Following the first operation, the article was removed from the barrel and wiped to remove substantially all traces of the synthetic organic abrasive particles, following which the article was subjected to a second operation wherein it was inserted into the barrel along with a natural organic abrasive particle. The natural organic abrasive particles were RLW-800 ground walnut shells obtained from Graviflo Corporation. In the second operation, the article was tumbled for a time period of about 10 to about 20 minutes. The barrel was rotated at a speed of 240 rpm, while the barrels revolved around the turret at a speed of 240 rpm.

The article was then removed from the barrel and subjected to a fatigue life test. This test is also called the Rotating Beam Survival test. In the fatigue life test, the article was subjected to a cyclic strain of 0.8%. The test is a cyclic bending fatigue test where a wire specimen is rotated at a fixed number of revolutions per minute through a known radius of curvature while immersed in 37° C. water or saline bath. Up to 10 wires can be tested at one time. Wires are placed in a machined radius slot in the test block with one end of the wire secured in a chuck. The chuck is connected to motor drive system that spins the chuck at the desired revolutions per minute. As the wire rotates it cycles through a tensile stress and a compressive stress at a strain equal to the radius of the wire divided by the sum of the radius of the wire and the radius of curvature of the test block measured to the neutral fiber. The free end of the wire is monitored optically for rotation and when rotation stops the number of cycles are recorded.

Fatigue life is the distribution of the cycles reached by failed parts. This describes number of cycles to failure. Fatigue survival is the number of parts that do not fail or survive the specified test cycle. These parts are still rotating when the test is suspended and the number of cycles to failure for these parts is unknown. For example if ten parts are tested and 5 fail at 50,000 cycles and 5 do not fail by the time the test is suspended then the average fatigue life is 50,000 cycles and the fatigue survival rate is 50%.

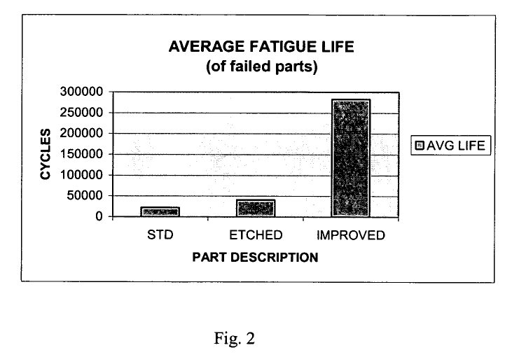

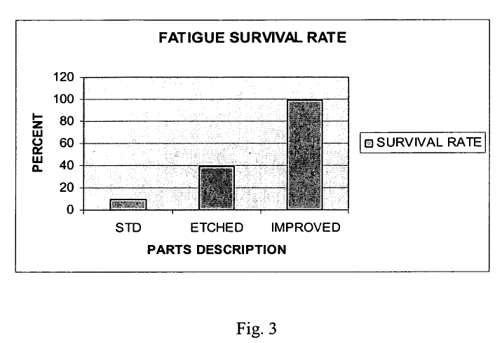

The results from the tests are shown in FIGS. 2 and 3. In addition to the samples that were polished by tumbling, samples were prepared by a standard method as well as by a chemical etching process. The samples prepared by the standard method and the chemical etching processes are comparative samples. FIG. 2 is graphical representation of a bar chart showing the average fatigue life for the samples prepared by the standard method, etched using chemical etching as well as for the samples that were subjected to polishing by the tumbling method. From the figure it may be seen that while the samples subjected to the standard method of preparation and the chemical etching process show average fatigue lives of less than 40,000 cycles, the sample subjected to polishing by the tumbling process shows a fatigue life of approximately 280,000 cycles. This represents a 700% improvement. Similarly the fatigue survival rate as shown in FIG. 3 for the sample polished by the tumbling process is about 95%, while the fatigue survival rate for the chemically etched sample is less than 40%. These results clearly indicate that the samples prepared by the tumbling process are superior to those prepared by the standard method as well as by the chemical etching process.

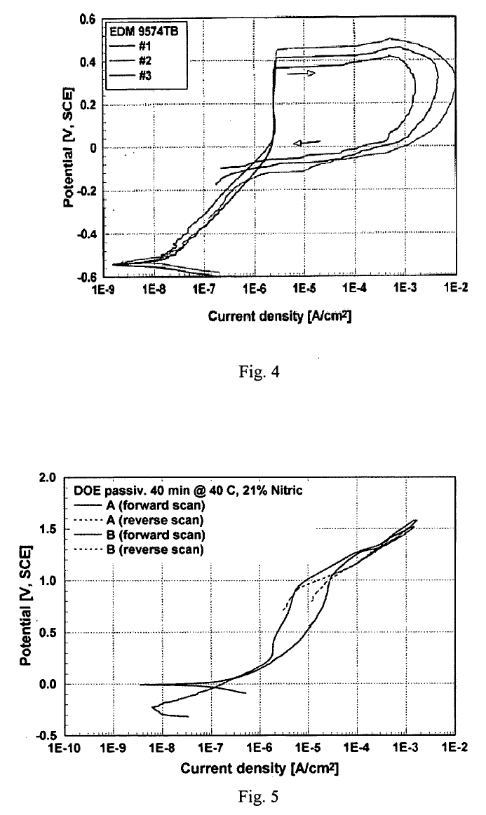

The corrosion resistance of barrel tumbled Ti-55.8% Ni wire samples was analyzed after a cyclic polarization corrosion test in a deaerated Hank's solution at 37° C., following the ASTM F2129-01 protocol. The cyclic polarization curves are plotted in FIG. 4. All of these curves exhibit passivity breakdown at 0.36/0.45V in reference to a saturated calomel electrode (SCE). Because NiTi alloys are passive alloys the breakdown potential is an important gauge on the resistance to localized pitting corrosion. During the reverse scan, the current density remains high until about 0V SCE and repassivation occurs at −0.073/−0.155V SCE.

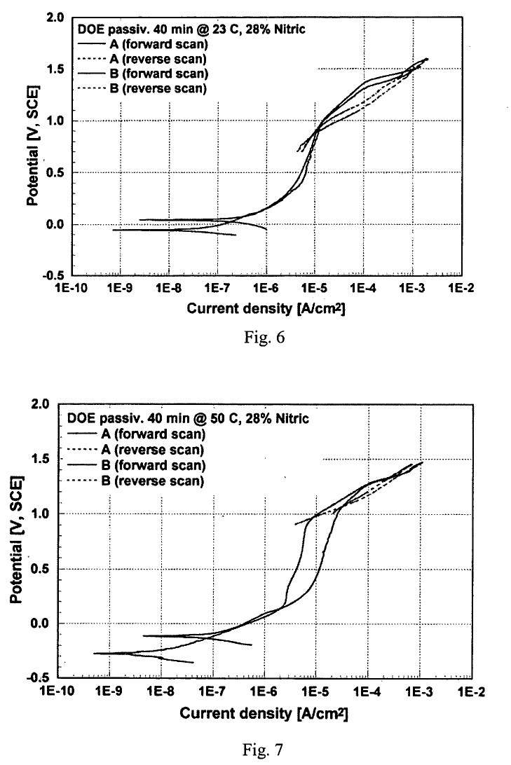

It was found that by passivation treatment of mechanically polished, i.e., barrel tumbled, NiTi wires in nitric acid solution of various concentrations, the corrosion resistance of the materials to pitting corrosion was significantly improved. FIG. 5 shows an example of cyclic polarization curves of two barrel tumbled Ti-55.8% Ni wire specimens after passivation treatment at 40° C. for 40 minutes in a 21 wt % nitric acid solution (70% assay mixed 30% in deionized water). Both curves exhibit current density increases at the end of passivity around 1.0V SEC and almost instant repassivation with only a small amount of hysteresis occurring during the reverse scan. The protection potentials for both specimens is about 1.0V SEC, which represents significant improvements over those for barrel tumbled specimens. FIG. 6 shows another example of cyclic polarization curves of 2 barrel tumbled Ti-55.8% Ni wire specimens after passivation treatment at 23° C. for 40 minutes in a 28 wt % nitric acid solution. Both curves are similar to those in FIG. 5, exhibiting breakdown and protection potentials around 1.0V SEC. FIG. 7 shows yet another example of 2 barrel tumbled Ti-55.8% Ni wire specimens after passivation treatment at 50° C. for 40 minutes in a 28 wt % nitric acid solution. Both curves are fundamentally similar to those in FIGS. 5 and 6, exhibiting breakdown and protection potentials around 0.9V SEC. High-energy barrel tumbling with subsequent passivation treatment in nitric acid solution significantly improves fatigue endurance and corrosion resistance for NiTi medical implants.

The aforementioned method of passivation is superior to that disclosed in “Passivation of nitinol wire for vascular implants—a demonstration of the benefits”, by B. O'Brien et al., Biomaterials, Vol. 23, pp. 1739-1748 (2002). The article discloses the improvement of corrosion resistance of heat-treated nitinol (NiTi) wire by nitric acid passivation. NiTi alloys in heat-treated condition have significant surface oxide and the breakdown potential after passivation appears at voltage of 0.4 to 1.2V. These results are much less consistent than our results. The wires so treated will not have the benefit of improved fatigue endurance.

### Example 2

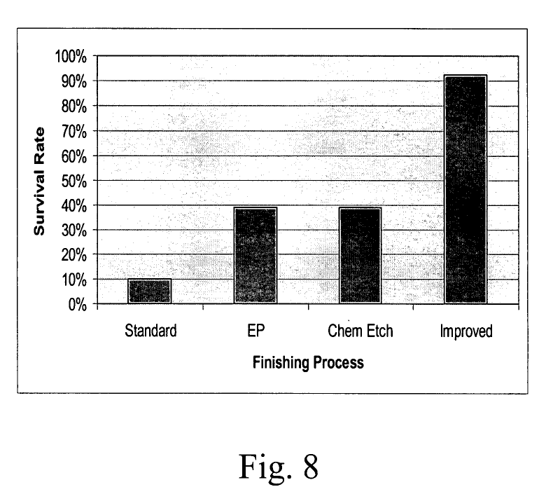

This example reflects the results obtained from 270 wire samples that were subjected to a cyclical fatigue test. The wire samples comprising titanium and 55.8 wt % nickel were tested to determine resistance to cyclical fatigue. The samples were split up into 6 lots and tested. A total of 270 samples were tested. The wires were tested on a rotating beam survival test to 90,000 cycles. The survival rate is the ratio of the number of samples that fail during this test to the number of samples that are present initially expressed as a percentage. If every wire sample in a batch lasted 90,000 cycles, then the sample was determined to have a 100% survival rate. On the other hand, if 97 out of 100 wires survived the test, then the survival rate was determined to be 97%. The wires have a diameter of 0.020 inches. The wire was first subjected to cold working in an amount of 40% and heat-treated at 525° C. for 10 minutes prior to being subjected to the finishing treatments. The wire samples were subjected to a cyclical strain of 0.8%. The results can be seen in the FIG. 8.

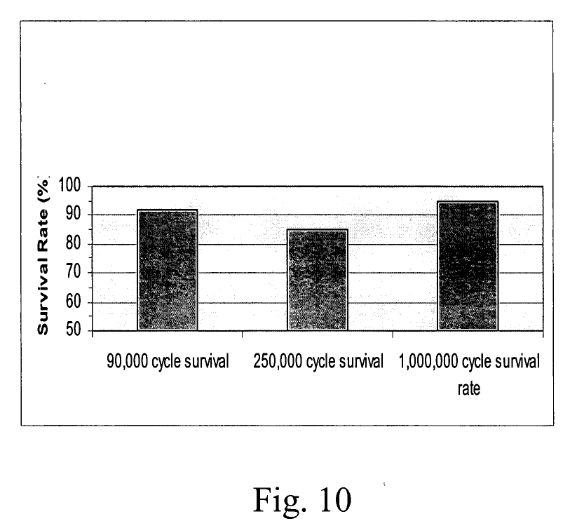

From the FIG. 8, it can be seen that each batch of samples averages a survival rate of greater than or equal to about 85%. Three batches have a survival rate of 100%. The average of the six samples is shown in the FIG. 10, which will be described later.

### Example 3

This example was conducted to demonstrate that wire samples subjected to polishing in a high-energy tumble machine and subsequently passivated can withstand a large number of fatigue cycles. The samples were split into three batches. Each batch was subjected to the rotating beam survival test. The samples were tested using the cyclic bending fatigue test of Example 1. The batch size and the number of cycles that each batch was subjected to are shown in Table 1.

TABLE 1

| Batch # | Batch Size | # of cycles |
|---|---|---|
| 1 | 270 wires | 90,000 |
| 2 | 60 wires | 250,000 |
| 3 | 20 wires | 1,000,000 |

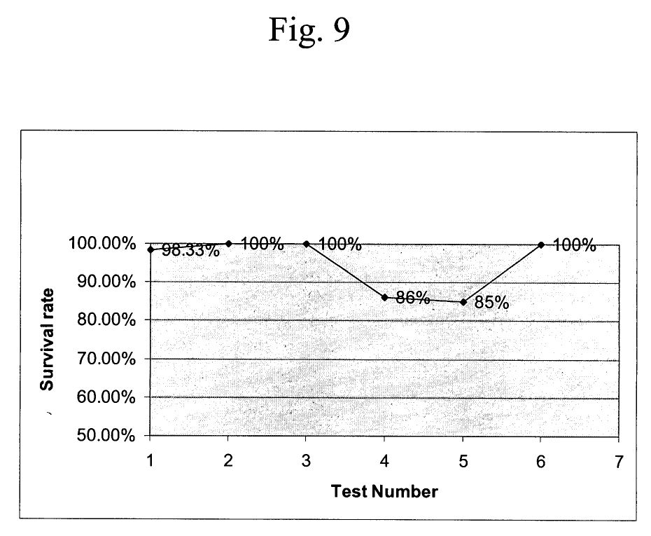

The results are shown in FIG. 9. FIG. 9 shows that all samples show a survival rate of greater than or equal to about 85%. The figure further shows that there is very little statistical difference in survival rates in this range of fatigue cycle tests.

### Example 3

In this example, wire samples having a composition comprising titanium and 55.8 wt % nickel were tested to determine resistance to cyclical fatigue. The wires were tested on a rotating beam survival test to 90,000 cycles. One wire sample was not subjected to any surface treatment while the other wire samples were subjected to various surface treatments to evaluate the effectiveness of the treatments on the wire under conditions of cyclical fatigue. The wire had a diameter of 0.020 inches. The wire was first subjected to cold working in an amount of 40% and heat-treated at 525° C. for 10 minutes prior to being subjected to the finishing treatments.

The results are shown in the FIG. 10. The sample titled “standard” was not subjected to any surface treatment after the heat treatment process. The sample titled “EP” was subjected to electropolishing. The electropolishing process starts with an acid etch to remove approximately 0.0007″ of material from the diameter of the wire. The part is then cleaned in several stages and then electrochemically polished to remove approximately 0.0003″ of material from the diameter of the wire. The part is then cleaned in several stages and then passivated in an acid bath. Finally the part is again cleaned in several stages.

The sample titled “Chem Etch” was subjected to chemical etching. The chemical etching process starts with a precleaning followed by a chemical etch to remove approximately 0.0010″ of material from the diameter of the wire. The part is then cleaned in several stages and then passivated in an acid bath. Finally the part is again cleaned in several stages. The sample titled “Improved” was subjected to the polishing process described in the Example 1 above. The samples were passivated after the polishing process was completed. A minimum of 100 samples were tested for each point.

FIG. 10 shows that the sample labeled “improved” which was subjected to polishing in the high-energy tumble machine followed by passivation can withstand the cyclical fatigue process more effectively than samples subjected to other finishing processes or those that are not subjected to any finishing process at all.

### Example 4

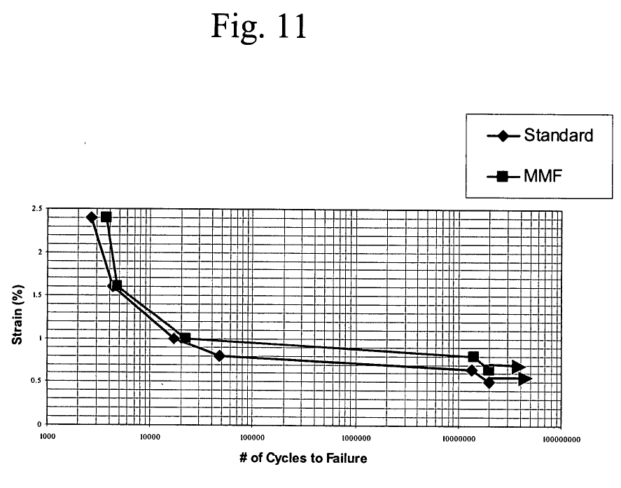

This example demonstrates the superior fatigue properties of samples that are subjected to finishing using the high-energy tumbling machine over samples that are not subjected to a finishing process. The samples were tested in the same manner as in Example 1 except that the percent strain is varied from 0.8 to 2.4 percent. The results are shown in FIG. 11. FIG. 11 is a plot depicting the percent strain versus the number of cycles to failure. Each point represents the average cycles to failure of 3 samples at that particular strain level. FIG. 11 clearly shows that specimens that are subjected to the high energy tumbling process show consistently better fatigue endurance that the samples that are not treated.

### Example 5

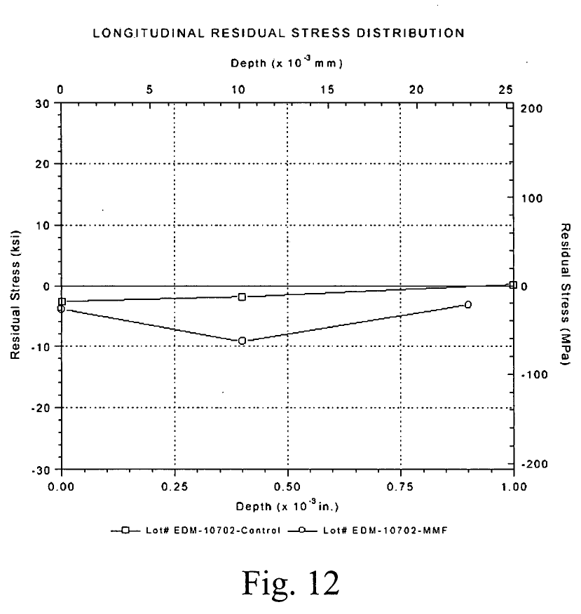

This example was conducted to determine the residual stress in specimens that were not subjected to finishing and those were subjected to finishing using the high-energy tumbling machine. In order to determine the residual stress, xray diffraction measurements were made at the surface and at nominal depths of 0.5×10−3 and 1×10−3 inches. Measurements were made in the longitudinal direction on the outside diameter of the wires at the mid-length of the group. The average residual stress depth distribution of the entire group is shown in the FIG. 12. FIG. 12 shows that the samples that were subjected to finishing have a higher residual compressive stress than standard specimens that were not subjected to finishing. The compressive stress is induced by the media in the high-energy tumbling process cold working the extreme outer fibers of the material.

From the date in the aforementioned examples, it may be seen that the samples subjected to polishing using the abrasive media described herein can develop compressive stresses of greater than or equal to about 30 MPa (megapascals), preferably greater than or equal to about 50 MPa and most preferably greater than or equal to about 70 MPa, after being subjected to 90,000 cycles in a fatigue test.

The materials can advantageously be subjected greater than or equal to about 90,000 cycles while having a survival rate of greater than or equal to about 85%. In one embodiment, materials subjected to the improved polishing methods described herein can be subjected greater than or equal to about 250,000 cycles while having a survival rate of greater than or equal to about 85%. In another embodiment, materials subjected to the improved polishing methods described herein can be subjected greater than or equal to about 1,000,000 cycles while having a survival rate of greater than or equal to about 85%.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. A method for polishing metallic articles comprising:
immersing a portion of the metallic article in abrasive media;
tumbling the metallic article in a centrifugal force field; and
passivating the metallic article in a passivating solution comprising an acid.

2. The method of claim 1, wherein the abrasive media comprises organic particles, inorganic particles, or a combination of organic and inorganic particles that have a bulk density of less than or equal to about 1.5 g/cm³.

3. The method of claim 2, wherein the organic particles are synthetic organic particles, natural organic particles, or a combination comprising at least one of the foregoing organic particles.

4. The method of claim 3, wherein the synthetic organic particles are derived from a thermoplastic polymer, a thermosetting polymer or a combination comprising at least one of the foregoing polymers.

5. The method of claim 4, wherein the thermoplastic polymer is an oligomer, an ionomer, a dendrimer, a copolymer or combinations comprising at least one of the foregoing thermoplastic polymers.

6. The method of claim 4, wherein the thermoplastic polymer is a polyacetal, a polyacrylic, a polymethylmethacrylate; a polyolefin; a polyalkyd, a polycarbonate, a polystyrene, a polyester, a polyamide, a polyamideimide, a polyarylate, a polyarylsulfone, a polyethersulfone, a polyphenylene sulfide, a polysulfone, a polyimide, a polyetherimide, a polytetrafluoroethylene, a polyetherketone, a polyether etherketone, a polyether ketone ketone, a polybenzoxazole, a polyoxadiazole, a polybenzothiazinophenothiazine, a polybenzothiazole, a polypyrazinoquinoxaline, a polypyromellitimide, a polyquinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyorganosiloxane, or combinations comprising at least one of the foregoing thermoplastic polymers.

7. The method of claim 3, wherein the thermosetting polymer is a polyurethane, an epoxy, a phenolic, a polyester, a polyamide, a polyorganosiloxane, or a combination comprising at least one of the foregoing thermosetting polymers.

8. The method of claim 3, wherein the synthetic organic particles comprise organic fillers, inorganic fillers or a combination comprising at least one of the foregoing fillers.

9. The method of claim 8, wherein the organic fillers are impact modifiers and wherein the inorganic fillers comprise metal oxides, metal carbides, metal silicates, metal carbonitrides, or a combination comprising at least one of the foregoing fillers.

10. The method of claim 8, wherein the organic fillers are naturally occurring and wherein the organic fillers are walnut shell particles, coconut shell particles, peach pits, brazil nut covers, cherry pits, apricot pits, plum pits, olive seeds, prune seeds, cob meal, grape seeds, peanut hulls, almond shells, cotton seed hulls, acorn shells, orange seeds, grapefruit seeds, lemon seeds, watermelon seeds, or a combination comprising at least one of the foregoing naturally occurring organic fillers.

11. The method of claim 2, wherein the natural organic particles are walnut shell particles, coconut shell particles, peach pits, brazil nut covers, cherry pits, apricot pits, plum pits, olive seeds, prune seeds, cob meal, grape seeds, peanut hulls, almond shells, cotton seed hulls, acorn shells, orange seeds, grapefruit seeds, lemon seeds, watermelon seeds, or a combination comprising at least one of the foregoing naturally occurring organic fillers.

12. The method of claim 1, wherein the centrifugal force field is applied by rotating the article in a first direction about a first axis, while causing the article to revolve in a second direction about a second axis.

13. The method of claim 1, wherein the first direction is the same as the second direction.

14. The method of claim 1, wherein the first direction is opposed to the second direction.

15. The method of claim 1, wherein energy used during the tumbling is about 0.1 to about 200 kilowatthour/kilogram.

16. The method of claim 1, wherein the tumbling is conducted for about 2 minutes to about 2 hours.

17. The method of claim 1, wherein the metallic article is a shape memory alloy.

18. The method of claim 1, wherein the metallic article is a nickel titanium alloy.

19. The method of claim 1, wherein the metallic article is a β titanium alloy having superelastic and/or superelastic properties.

20. The method of claim 1, wherein the acid is nitric acid

21. A method comprises:
immersing a portion of the metallic article in a first abrasive media;
tumbling the metallic article in a first centrifugal force field;
immersing the metallic article in a second abrasive media;
tumbling the metallic article in a second centrifugal force field; and
passivating the metallic article in a passivating solution comprising an acid.

22. The method of claim 21, wherein the metallic article is a shape memory alloy.

23. The method of claim 21, wherein the metallic article is a nickel titanium alloy.

24. The method of claim 21, wherein the metallic article is a β titanium alloy having superelastic and/or superelastic properties.

25. The method of claim 21, wherein the first abrasive media comprises organic particles, inorganic particles, or a combination of organic and inorganic particles that have a bulk density of less than or equal to about 1.5 g/cm³.

26. The method of claim 25, wherein the organic particles are synthetic organic particles, natural organic particles, or a combination comprising at least one of the foregoing organic particles.

27. The method of claim 26, wherein the synthetic organic particles are derived from a thermoplastic polymer, a thermosetting polymer, or a combination comprising at least one of the foregoing polymers.

28. The method of claim 27, wherein the thermoplastic polymer is an oligomer, an ionomer, a dendrimer, a copolymer or combinations comprising at least one of the foregoing thermoplastic polymers.

29. The method of claim 28, wherein the thermoplastic polymer is a polyacetal, a polyacrylic, a polyalkyd, a polycarbonate, a polystyrene, a polyester, a polyamide, a polyamideimide, a polyarylate, a polyarylsulfone, a polyethersulfone, a polyphenylene sulfide, a polysulfone, a polyimide, a polyetherimide, a polytetrafluoroethylene, a polyetherketone, a polyether etherketone, a polyether ketone ketone, a polybenzoxazole, a polyoxadiazole, a polybenzothiazinophenothiazine, a polybenzothiazole, a polypyrazinoquinoxaline, a polypyromellitimide, a polyquinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyorganosiloxane, or combinations comprising at least one of the foregoing thermoplastic polymers.

30. The method of claim 27, wherein the thermosetting polymer is a polyurethane, an epoxy, a phenolic, a polyester, a polyamide, a polyorganosiloxane, or a combination comprising at least one of the foregoing thermosetting polymers.

31. The method of claim 26, wherein the synthetic organic particles comprise organic fillers, inorganic fillers or a combination comprising at least one of the foregoing fillers.

32. The method of claim 31, wherein the organic fillers are impact modifiers and wherein the inorganic fillers comprise metal oxides, metal carbides, metal silicates, metal carbonitrides, or a combination comprising at least one of the foregoing fillers.

33. The method of claim 31, wherein the organic fillers are naturally occurring and wherein the organic fillers are walnut shell particles, coconut shell particles, peach pits, brazil nut covers, cherry pits, apricot pits, plum pits, olive seeds, prune seeds, cob meal, grape seeds, peanut hulls, almond shells, cotton seed hulls, acorn shells, orange seeds, grapefruit seeds, lemon seeds, watermelon seeds, or a combination comprising at least one of the foregoing naturally occurring organic fillers.

34. The method of claim 21, wherein the second abrasive media comprises natural organic particles, and wherein the natural organic particles are walnut shell particles, coconut shell particles, peach pits, brazil nut covers, cherry pits, apricot pits, plum pits, olive seeds, prune seeds, cob meal, grape seeds, peanut hulls, almond shells, cotton seed hulls, acorn shells, orange seeds, grapefruit seeds, lemon seeds, watermelon seeds, or a combination comprising at least one of the foregoing naturally occurring organic fillers.

35. The method of claim 21, wherein the first centrifugal force field is applied by rotating the article in a first direction about a first axis, while causing the article to revolve in a second direction about a second axis, while the second centrifugal force field is applied by rotating the article in a first direction about a first axis, while causing the article to revolve in a second direction about a second axis.

36. The method of claim 21, wherein the first centrifugal force field is not equal to the second centrifugal force field.

37. The method of claim 21, wherein the first centrifugal force field is equal to the second centrifugal force field.

38. The method of claim 35, wherein the first direction is the same as the second direction.

39. The method of claim 35, wherein the first direction is opposed to the second direction.

40. The method of claim 21, wherein energy used during the method is about 0.1 to about 200 kilowatthour/kilogram.

41. The method of claim 21, wherein the acid is nitric acid.

42. An article manufactured by the method of claim 1.

43. An article manufactured by the method of claim 21.
